(19) United States
(12) Patent Application Publication
(10) Pub. No.: US 2008/0040863 A1
(43) Pub. Date: Feb. 21, 2008

(54) Apparatus for Setting, Removing and Maintaining Doors

(76) Inventors: Jean-Noel Guillore, Riec Sur Belon (FR); Paul Janin, Cran-Gevrier (FR)

Correspondence Address: DEFILLO & ASSOCIATES, INC., P.O. Box 14104, Clearwater, FL, 33766, US

(21) Appl. No.: 11/629,331

(22) PCT Filed: Jun. 15, 2005
(86) PCT No.: PCT/FR05/01481

§ 371 Date: Dec. 11, 2006

(30) Foreign Application Priority Data
Jun. 17, 2004 (FR) 0406547
Jul. 13, 2004 (FR) 0407788
Apr. 15, 2005 (FR) 0503788

(51) Int. Cl. B66F 15/00

(52) U.S. Cl. 7/166

(57) ABSTRACT

The invention concerns an apparatus comprising a lever (1), a fulcrum (13) and a maneuvering pedal (4), said lever being actuated by the operator's foot acting as a driving and directive force to lift the door (12), move it and position coaxially its frame hinges; the shorter arm of the lever (1) being provided at its end with a grip handle (21) capable of being slid under the door to be maneuvered, while the end of its longer arm is equipped with a pivoting roller (8); at the junction of its arms the lever (1) is secured to a perpendicular supporting element acting as fulcrum (13) including roller means supported on an independent rigid plane (13) whereon the apparatus moves.

### CROSS REFERENCE TO RELATED APPLICATION

This application is a national stage of PCT/FR2005/001481 filed Jun. 15, 2005 and based upon French Application No. FR 0406547 filed Jun. 17, 2004, French Application No. 0407788 filed Jul. 13, 2004, and French Application No. 0503788 filed Apr. 15, 2005, under the International Convention.

### FIELD OF THE INVENTION

The present invention is from the field of precise handling gear and the invention particularly relates to an apparatus intended to facilitate the setting, removing and maintaining of objects such as, but not exclusive to, swinging doors.

It is known that the placing and positioning of heavy, bulky and thin objects, such as hinge doors, sliding doors and windows, as non-exclusive examples, necessitate precise adjustments since the male and female parts must be moved together before the parts can be joined coaxially. Currently, this operation is carried out manually. The door is raised, then positioned by successive approaches. This operation is difficult since the user, while he carries the load, must align the hinges coaxially. This leads to fatigue, loss of time, and numerous attempts that are often unproductive.

### PRIOR ART

The known systems are levers of the type comprising a rigid bar pivoting around a support axis situated between the drive force and the resistance. These are summary systems that are not satisfactory from the practical point of view.

### SUMMARY OF THE INVENTION

The apparatus according to the invention allows, by means activated by the foot of the user acting as a drive and directive force, the door to be raised and movements from bottom to top, front to back, right to left and vice versa to be executed, while the hands of the user no longer carry the load and are free to intervene.

The apparatus is comprised of a lever wherein one of the arms, preferably the shorter arm, has its extremity in the form of an angle section acting as a grip handle wherein the horizontal strip, although thin but sufficiently solid, is capable of sliding under a door, while the other arm, preferably longer, whose extremity is advantageously equipped with a pivoting roller, supports a pedal in the form of a stirrup or channel in which the front of the foot of the user is engaged and blocked; at the junction of these arms, the lever is made integral with a supporting element equipped with castor wheels supported on a plane, while being able to move, the plane comprised of a rigid plate advantageously equipped with vertical flanges on at least one side so as to maintain the apparatus on the plate.

According to an embodiment of the invention, the lever is comprised, in its entire length, of a channel equipped with rigidification elements, for example in the form of a U-shaped section capable of receiving the foot of the operator on its horizontal bottom with a suitable width, to maintain the foot between its two lateral vertical sides with a suitable height, this channel ensuring the functions of a pedal and a stirrup for the free positioning of the foot.

According to another embodiment of the invention, the lever comprises means for varying the length of the arms, for example the lever is comprised of two tubular parts fitted together and adjusted with relation to each other by means of latches, pins or screws.

According to another characteristic of the invention, the support balls of the lever mobile on the maneuvering plane are held in sockets fixed to the two extremities of an angle section, perpendicularly integral with the lever arms.

According to another characteristic of the invention, a cap covers the sockets and their respective balls in order to temporarily offer a larger bearing surface during the application of an exceptionally high pressure, for example to unhinge rusted fittings.

According to another characteristic of the invention, the grip handle capable of sliding under the door for raising the door is articulated by hinges with a fitting that is made perpendicularly integral with the extremity of the short arm of the lever.

According to another characteristic of the invention, the front of the foot of the user is held in the stirrup or channel by means of straps or any other similar means.

According to another characteristic of the invention, the stirrup or channel for holding the foot of the operator is made to be slip-resistant by an appropriate sealer or coating.

According to another characteristic of the invention, the grip handle in the form of an angle section is interchangeable and adjustable in height with relation to the fitting that joins the handle to the short arm of the lever by means of, for example, endless screws and nuts.

According to another characteristic of the invention, the supporting element integral with the castor wheels is adjustable with relation to the arm of the lever to which it is joined by means of, for example, an endless screw and a nut.

According to another characteristic of the invention, a roll stop with an adjustable length, for example a screw situated under the longer arm and near its extremity, allows the downward course of said arm to be limited, for example to prevent unhinging.

According to another characteristic of the invention, two of the lateral edges of the rigid plate on which the apparatus moves are wide and high to receive the door in the ready position. Therefore, to withdraw or replace the grip handle under the door, it is not necessary to manually raise the door.

The combination of using castor wheels and the rigid plate is essential for the precision of the movements to execute.

According to another characteristic of the invention, the small arm of the lever comprises an element for blocking the top of the toe box of the operator.

According to another characteristic of the invention, an extension arm, preferably telescopic and removable, is fitted on the vertical flange of the angle section comprising the grip handle; the extension arm comprises at its free extremity one or more supports having a form adapted to the object to support, for example a half-cylinder whose hollow part receives a vacuum cup handle used for, among other uses, handling partition glass.

### DESCRIPTION OF THE DRAWINGS

FIG. 1 is a perspective view of the apparatus which is the object of the invention.

FIG. 2 represents the previous apparatus seen from below with a door on its grip handle.

FIG. 3 is a perspective view of the apparatus in the position of raising a door.

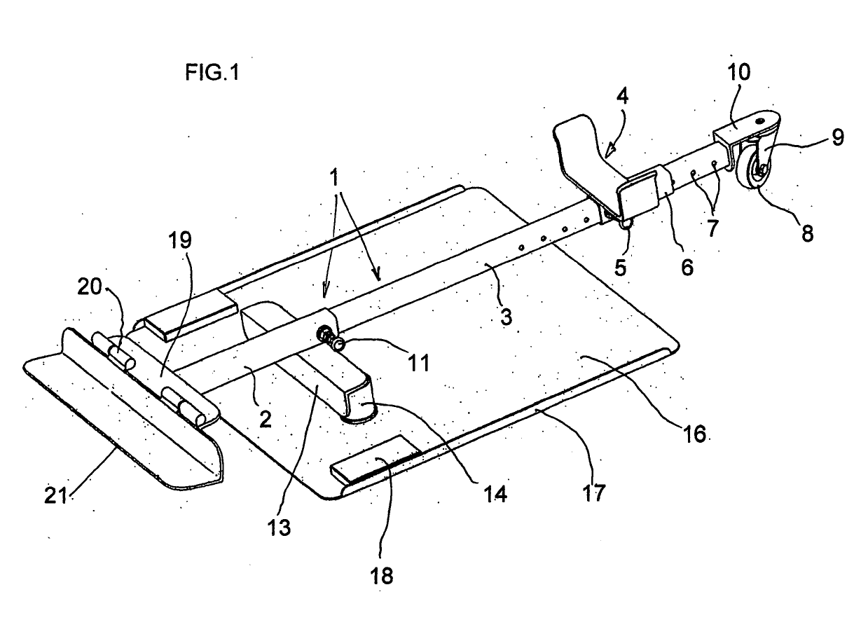

### DESCRIPTION OF AN EXAMPLE OF EMBODIMENT

As shown in the drawings, the apparatus comprises a lever 1 comprised of two arms 2 and 3, for example in circular or square shaped nested tubes.

On the long arm 3 may slide a stirrup 4 held at the desired position by a blocking element such as a latch 5 or a pin or screw. For this purpose, the stirrup 4 is integral with a slide 6 capable of sliding on the arm 3 and of being blocked in the position chosen by the spline 5 introduced in one of the corresponding holes 7 disposed along the arm 3.

The extremity of the long arm 3 is equipped with a pivoting roller 8 centered in a yoke 9 that may rotate 360° with relation to a fitting 10 to which it is attached.

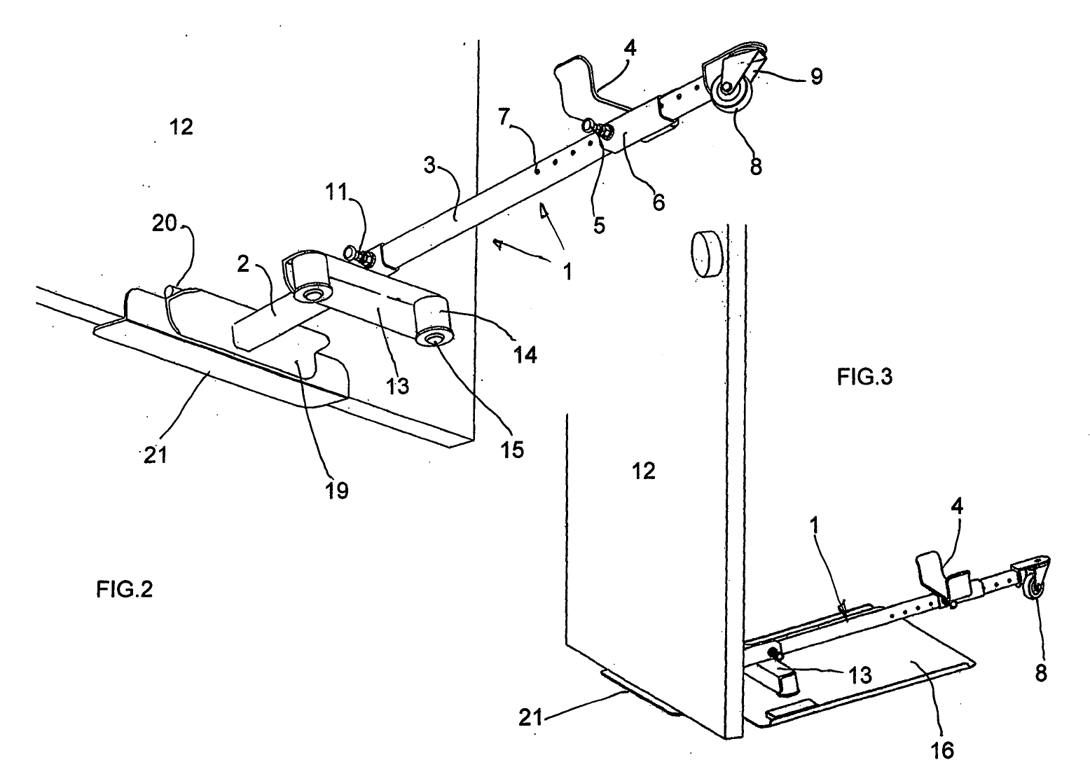

The short arm 2 of the lever 1 joined with the long arm 3 is blocked at the desired length by a blocking element such as a screw 11 or any other suitable means. By sliding the two arms 2 and 3, the length of the lever 1 is therefore varied depending on the load to raise, in this case the door 12 represented in FIGS. 2 and 3.

The short arm 2 is made integral with the fulcrum 13 in the form of an angle section disposed perpendicularly to said arm. At each extremity, the horizontal flange of the fulcrum 13 supports a socket 14 retaining a ball 15 that is capable of allowing the displacement of lever 1 on a smooth and rigid plane 16 and comprised, as a non-exclusive example, of sheet metal. Furthermore, this plane is advantageously equipped on two of its sides with flanges 17 and supports 18. This plane 16 is reinforced by a plate, for example in plywood, ensuring contact with the floor, the plate may be cut by an opening allowing it to be secured.

The free extremity of the short arm 2 is integral with a fitting in an angle section 19 joined, by hinges 20, to a grip handle 21 in the form of an angle section. The angle sections 19 and 21 are disposed perpendicularly to the short arm 2 and are inter-articulated by their vertical flange in such a way as to form an abutment.

As shown in FIG. 3, the apparatus is close to the door 12 to be raised for setting or removing the door and the horizontal flange of the grip handle 21 just has to be engaged under said door and, by using the foot fixed in the stirrup acting on long arm 3 of lever 1 leaning on fulcrum 13, the door may be raised easily and effortlessly.

For setting the door, the door just has to be positioned in the frame at the level of the hinges, pressure on the pedal is then gently released to leave the hinges joined coaxially. The reverse operation allows the door to be removed.

One may also envision utilizing the apparatus for lifting tasks other than those described.

In addition, any modifications to the useful details may be made to the embodiment of the apparatus, particularly in that which relates to the sections and materials intended to comprise the various elements, without necessarily going beyond the scope of the invention.

Therefore, under any other simple embodiment of the invention, the lever 1 is comprised, in its entire length, of a U-shaped section in the bottom of which the foot of the operator presses and may guide the apparatus in its displacements on plate 16 to bring the grip handle under the door and positioned under the blocking element.

1. An apparatus for setting, removing and maintaining swinging doors and other objects, comprises comprising in combination:
a lever (1),
a fulcrum (13) and
a maneuvering pedal (4),
said lever being activated by the foot of the user acting as a drive and directive force for raising the door (12), displacing the door and coaxially positioning its hinges,
said lever (1) being comprised of two arms (2, 3)
wherein the shorter (2) has its extremity equipped with a grip handle (21) capable of sliding under the door to maneuver, while the other longer arm (3) is equipped at its extremity with a pivoting roller (8) and that at the junction of its arms, the lever (1) is integral with a supporting element (13) equipped with rolling means (15) supported on a smooth and rigid plane (16) on which the apparatus moves.

2. The apparatus according to claim 1, wherein the two arms (2, 3) comprising the lever (1) are tubular and nested and integral with a blocking means (11) in order to adjust the length of said lever.

3. The apparatus according to claim 1, wherein the lever (1) is comprised, in its entire length, of a U-shaped section integral with the supporting element (13) comprising at one of its extremities the grip handle (21) and at the other extremity the pivoting roller (8), said section acting as the pedal (4).

4. The apparatus according to claim 1, wherein the pedal (4) is a stirrup fixed on a slide (6) capable of sliding on the long arm (3) of the lever (1) and held in the desired position by a latch (5), pin or screw engaged in holes (7) of said arm and slide.

5. The apparatus according to claim 1 wherein the foot of the user is held on the pedal (4) by a fixation means.

6. The apparatus according to claim 1 wherein the small arm of the lever (1) comprises an element for blocking the top of the toe box of the operator.

7. The apparatus according to claim 1, wherein the grip handle (21) of the door (12) is an angle section articulated to a fitting (19) fixed perpendicularly to the free extremity of the short arm (2) of the lever (1) by hinges (20).

8. The apparatus according to claim 1, wherein the supporting element (13) joined to the lever (1) is an angle section whose extremities are equipped with sockets (14), each retaining a ball (15).

9. The apparatus according to claim 1 wherein the grip handle (21) of the door (12) and the axle (13) are adjustable in height with relation to the short arm (2).

10. The apparatus according to claim 8, wherein the adjustments in height of the grip handle (21) and of the fulcrum (13) are produced by nuts and endless screws.

11. The apparatus according to claim 1, wherein the plane (16) for displacement of the device comprises a peripheral flange (17) with lateral contact pieces (18).

12. The apparatus according to claim 1, wherein the roller (8) equipping the extremity of the long arm (3) of the lever (1) is centered on a fitting (10) enabling the roller to pivot 360°.

13. The apparatus according to claim 1, wherein the plane (16) for displacement of the device comprises a carrying handle.

14. The apparatus according to claim 1 wherein a telescopic and removable extension arm is fitted on the grip handle (21) to support any object manipulation organ whatsoever.
